(19) United States
(12) Patent Application Publication
(10) Pub. No.: US 2002/0162273 A1
(43) Pub. Date: Nov. 7, 2002

(54) Mulch for use with indoor potted plants and method of manufacturing mulch

(76) Inventors: James R. Stein, Moscow, ID (US); Carol A. Stein, Moscow, ID (US)

Correspondence Address: Law Office of Duncan Palmatier, Suite 5, 530 South Asbury Street, Moscow, ID, 83843, US

(21) Appl. No.: 10/183,110

(22) Filed: Jun. 25, 2002

Related U.S. Application Data
(62) Division of application No. 09/678,517, filed on Oct. 3, 2000.
(60) Provisional application No. 60/157,869, filed on Oct. 6, 1999.

(51) Int. Cl. A01G 7/00

(52) U.S. Cl. 47/9

(57) ABSTRACT

Bark chips articles for use as mulch for houseplants. A mulch composition is formed of Douglas Fir bark that has been chipped to have a longest dimension in the range of about 0.5 cm to about 3 cm (averaging a length of about 1 cm). The bark chips have been treated chemically so that they will not float when doused with water. A process of making the mulch composition includes selection of appropriate bark material from which the chips are to be formed, chipping the bark, and sterilizing it prior to one or more chemical treatment processes.

### CROSS REFERENCE TO RELATED APPLICATIONS

This is a DIVISIONAL APPLICATION of pending prior application Ser. No. 09/678,517, filed on Oct. 3, 2000, entitled MULCH FOR USE WITH INDOOR POTTED PLANTS AND METHOD OF MANUFACTURING MULCH.

The 09/678,517 application claimed priority under 35 U.S.C. § 119(e) from provisional patent Application No. 60/157,869, filed Oct. 6, 1999. The 60/157,869 and 09/678,517 Applications are hereby incorporated herein by reference.

### BACKGROUND OF THE INVENTION

1. Field of the Invention

The present invention relates generally to the field of plant care. More particularly, the present invention relates to tree bark nugget mulch for use with potted plants.

2. Background Information

The landscaping industry uses organic mulch around outdoor plantings. Homeowners also purchase and use mulch for landscaping purposes around trees and in flower beds.

Organic landscaping mulch is a by product of the wood products industry and is often sold in bulk (i.e., by the truckload), particularly to professional landscapers. Sometimes the bulk mulch is bagged into car trunk-sized (i.e., 2-3 cu. ft.) bags for convenient sale to homeowners.

Conventional mulch is tailored for the needs of outdoor plants and is sized in chunks that are too large to be blown away by the wind or washed away easily by rain and irrigation runoff. Such outdoor use mulch is ineffective for use with potted plants. That is because in many cases the space between the base of the plant and the rim of the pot is smaller than most of the mulch chunks.

Plant care products for potted plants (generally tropical plants for growing indoors) include plant food spikes, plant vitamins, and the like. No mulch product has been developed for use appropriate to indoor, potted plants.

Thus, what is needed is mulch that affords the advantages of soil cover for potted plants.

### SUMMARY OF THE INVENTION

It is an object of the present invention to retard evaporation of moisture from the soil surrounding a potted plant.

It is another object of the present invention to provide mulch articles that enrich potting soil and act as a soil conditioner.

It is yet another object of the present invention to provide mulch articles that protect houseplants from temperature shock by moderating temperature changes in the potting soil by acting as an insulating blanket on top of the soil.

It is still another object of the present invention to provide mulch articles that enhance the appearance of potted plants.

It is a further object of the present invention to provide mulch articles that do not float when exposed to water.

It is an additional object of the present invention to provide mulch articles that are combined with a plant nutrient composition.

It is another object of the present invention to provide mulch articles that are combined with a pesticide composition and/or fungicide composition.

Still another object of the present invention is to combine mulch chips with an odorant composition so that the mulch has an air freshener functionality.

The above objects are achieved by mulch articles formed of Douglas Fir bark that has been chipped to have a longest dimension in the range of about 0.5 cm to about 3 cm.

### BRIEF DESCRIPTION OF THE DRAWINGS

Additional objects and advantages of the present invention will be apparent in the following detailed description read in conjunction with the accompanying drawing figures.

FIG. 1 illustrates a mulch article, according to an embodiment of the present invention, surrounding the base of a potted plant.

FIG. 2 illustrates a flow chart of a process for manufacturing mulch according to an embodiment of the present invention.

### DETAILED DESCRIPTION OF THE INVENTION

Mulch chips embodied according to the present invention will meet the needs of the potted houseplant grower by providing a potted houseplant mulch that:

Reduces moisture evaporation rates from potting soil, thereby permitting the convenience of less frequent watering;

Provides soil amendment benefits by conditioning and enriching the soil;

Moderates rapid soil temperature changes, thereby protecting houseplants from temperature shock; and

Enhances the appearance of potted houseplants.

Western firs (in particular, Douglas Fir) have been discovered to be the most suitable for chipping as bark mulch for potted houseplants. A significant factor in choosing suitable bark mulch is the aesthetic appearance of the mulch. Bark nuggets having a dark reddish brown, rich, consistent coloration have been found to be most attractive to those in the market place. Western firs tend to meet these criteria well.

However, fir bark has a tendency to float that can be problematic. If the mulch chips float when the potted houseplant is being watered, the chips have a tendency to bunch up toward one side of the pot, giving an unpleasing appearance. Mulch made from certain plants does not have this problem. For example, cypress and cedar based mulches tend to stay put and not float when they are watered. The aesthetic appearance of these mulches is not as suitable, however, as that of western fir bark chips.

According to a preferred embodiment of the present invention, the fir bark chips are prevented from floating away by chemically treating the chips. A surfactant-type wetting agent is applied to the chips. The presence of the wetting agent on the chips causes the surface tension of the water to break down, thus allowing the water to wash over, around, and through the chips, rather than the chips being buoyed up by the water.

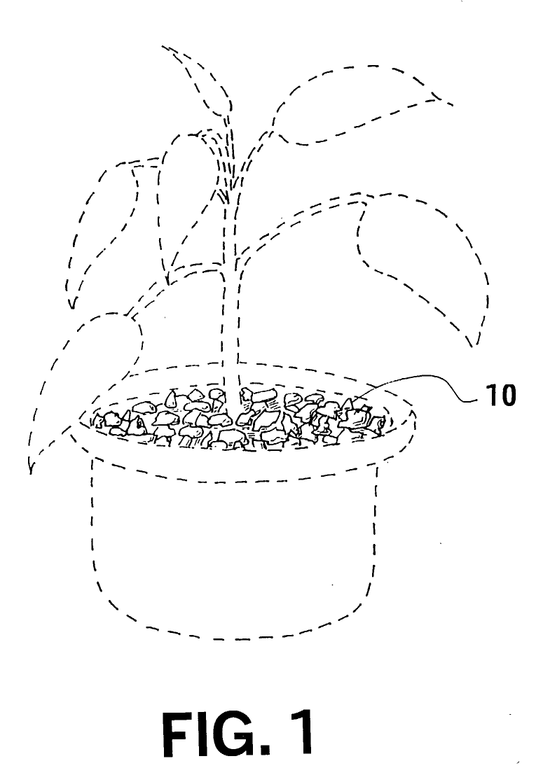

Referring to FIG. 1, mulch chips 10 according to an embodiment of the present invention are shown surrounding the base of a plant (shown in phantom) disposed in a pot (also shown in phantom).

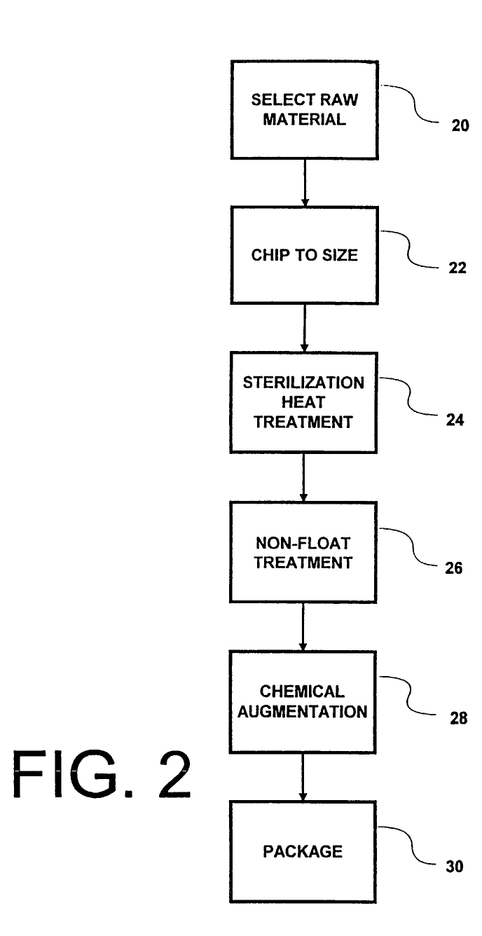

Referring to FIG. 2, a process for manufacturing mulch according to an embodiment of the present invention is outlined. Appropriate raw material is selected 20, most preferably Douglas Fir bark, although other species of western fir serve well. The selected bark is comminuted 22 into chips (or nuggets) of an aesthetically appropriate size, averaging about 1 cm long. The chipped bark is heat treated 24 to sterilize it. The sterilized chips are treated 26 to prevent them from floating in the event that they are doused with water. Optionally, any of several types of chemical augmentation 28 are performed to impregnate or coat the chips with pesticides, odorants, etc. to provide the bark with additional useful functionalities. The final phase of the manufacturing process is to package 30 the mulch chips in bags. The bags used for packaging are preferably small (about two quarts) because the quantities that will be needed over a reasonable period of time are so much smaller than is needed for outdoor landscaping. For convenience, the bags are re-sealable ZIPLOCK™ type bags so that unused portions of the packaged mulch can be stored in the same package.

Another important consideration for mulch for indoor houseplants is the size of the mulch particles. When tree bark is chipped into “nuggets”, the industry practice is to make the nuggets about two to three inches long. Although this is suitable for garden paths, such large nuggets are simply unworkable in the small pots that many houseplants are kept in. They just don't fit well and they look bad.

For use with potted houseplants, the mulch chips should be no longer than about 3 cm. A preferable range of chip length is from about 0.5 cm to about 3 cm. Being a natural product the chip size in a given lot of mulch tends to vary. The average chip size is preferably about 1 cm in length.

Preferably the mulch is sterilized by heat treatment. The heat sterilization is to neutralize fungus, bacteria, insects, and other organisms that may potentially harm plants to which the mulch is applied.

According to an alternate embodiment, the mulch chips are augmented with a fungicide composition and/or a pesticide composition. This increases the ease of plant care by building pest and fungus prophylaxis right into the mulch.

Preferably the fungicide and/or pesticide composition is impregnated into the mulch chips by high pressure treatment. This makes sure that the composition penetrates deeply into each chip so that it can leach out over time into the soil. The composition can optionally be coated onto the outside of the mulch chips, either in lieu of or in addition to the pressure treatment. The coating may be applied by either a soaking process or a spraying process. The exterior coating will have a tendency to disperse into the soil quickly rather than as a time release action.

According to another alternate embodiment, the mulch chips are augmented with plant nutrients. The plant nutrients may include fertilizer, as well as a soil amendment composition to alter the pH of the soil. Some plants prefer base soil, whereas others prefer acid soil. Alternate formulations are provided, tailored to these diverse plant needs. The nutrient compositions are applied to the mulch chips in similar manner to the methods described above with respect to pesticide and fungicide.

According to yet another alternate embodiment, the mulch chips have an air freshener functionality. This is accomplished by applying an odorant (pine, lemon, cinnamon, pot pourri, etc.) to the mulch chips in similar manner to the methods described above with respect to pesticide and fungicide.

What I claim is:

1. A mulch composition comprising:
a plurality of bark chips formed from bark of a western fir tree, the bark chips having a surfactant-type wetting agent applied thereto, wherein the length of the bark chips is in the range of about 0.5 cm to about 3 cm.

2. The mulch composition of claim 1, wherein the average length of the bark chips is about 1 cm.

3. The mulch composition of claim 1, wherein the bark chips are subjected to heat treatment.

4. The mulch composition of claim 1, wherein the bark chips are treated with a pesticide.

5. The mulch composition of claim 4, wherein the bark chips are treated with a pesticide by impregnating the pesticide into the bark chips under high pressure.

6. The mulch composition of claim 1, wherein the bark chips are treated with a fungicide.

7. The mulch composition of claim 6, wherein the bark chips are treated with a fungicide by impregnating the fungicide into the bark chips under high pressure.

8. The mulch composition of claim 1, wherein the bark chips are treated with a nutrient.

9. The mulch composition of claim 8, wherein the bark chips are treated with a nutrient by impregnating the nutrient into the bark chips under high pressure.

10. The mulch composition of claim 1, wherein the bark chips are treated with an odorant.

11. The mulch composition of claim 10, wherein the bark chips are treated with an odorant by impregnating the odorant into the bark chips under high pressure.

12. A mulch composition comprising bark chips from a western fir tree, wherein the bark chips are no larger than about 3 cm, and wherein the bark chips are subjected to heat treatment.

13. The mulch composition of claim 12, wherein the bark chips are treated with a wetting agent.

14. The mulch composition of claim 12, further comprising a means for applying a pesticide.

15. The mulch composition of claim 12, further comprising a means for applying a fungicide.

16. A process for manufacturing an indoor mulch composition comprising the steps of:
selecting tree bark chips no larger than about 3 cm,
treating the bark chips with heat, and
treating the bark chips with a surfactant-type wetting agent.

17. The process of claim 16, further comprising the step of treating the bark chips with a pesticide.

18. The process of claim 16, further comprising the step of treating the bark chips with a fungicide.

19. The process of claim 16, further comprising the step of treating the bark chips with a nutrient.

20. The process of claim 16, further comprising the step of treating the bark chips with an odorant.
